(19) United States
(12) Patent Application Publication
(10) Pub. No.: US 2020/0397196 A1
(43) Pub. Date: Dec. 24, 2020

(54) KITCHEN CABINET KNOCK DOWN STYLE PAN AND POT LID ORGANIZER RACK HOLDER

(71) Applicant: Shenzhen Hanwei Electronic Commerce Co., Ltd., Shenzhen (CN)

(72) Inventor: Qingzhi Nie, Shenzhen (CN)

(21) Appl. No.: 16/449,479

(22) Filed: Jun. 24, 2019

(51) Int. Cl. A47J 47/16; A47B 47/00; A47B 55/02; A47B 57/56; A47B 57/34

(52) U.S. Cl. CPC A47J 47/16; A47B 47/0058; A47B 57/34; A47B 57/562; A47B 55/02

(57) ABSTRACT

A kitchen cabinet knock down style pan and pot lid organizer rack holder, including a main frame; at least one first sub-frame, the at least one first sub-frame is disposed at intervals, the first sub-frame is mounted on one side of the main frame; the other side of the main frame is in contact with the support surface as a first use support structure; the second sub-frame, the second sub-frame and the first sub-frames are arranged in parallel intervals or non-parallel intervals, the second sub-frame is located on the edge side of the main frame, and the second sub-frame is provided with a protrusion portion; the protrusion portion and the edge side of the main frame can be in contact with the support surface to work as the second use support structure.

### TECHNICAL FIELD

The present disclosure relates to kitchen pan and pot lid organizer rack holder, in particular to a kitchen cabinet knock down style pan and pot lid organizer rack holder.

### BACKGROUND

Most of the kitchen cabinet knock down style pan and pot lid organizer rack holders of the existing kitchens are in a single use form, such as setting a number of storage compartments in the locker of the kitchen, and then placing the dishes, the dishes, the cruet, etc. into the corresponding storage compartments, which is a fixed structure, the use state cannot be changed.

The existing lids are usually placed on the table, the existing kitchen cabinet knock down style pan and pot lid organizer rack holders can only hold the dishes, the dishes, the cruet and etc., however, the lids cannot be placed on the existing kitchen cabinet knock down style pan and pot lid organizer rack holders.

### SUMMARY OF THE DISCLOSURE

In view of the above-discussed deficiencies of the prior art, the object of the present disclosure is, to provide a kitchen cabinet knock down style pan and pot lid organizer rack holder for solving the problem of the objects placement in the kitchen in the prior art.

In order to realized the above object and other relevant object, the present disclosure is to provide a kitchen cabinet knock down style pan and pot lid organizer rack holder, including:

a main frame;

at least one first sub-frame, wherein each of the at least one first sub-frame is disposed at intervals, the first sub-frame is mounted on one side of the main frame; the plane in which the main frame is located is at an angle to the plane in which the first sub-frame is located, and the other side of the main frame can be in contact with the support surface to work as a first use support structure;

the second sub-frame, wherein the second sub-frame and the first sub-frames are arranged in parallel intervals or non-parallel intervals, the second sub-frame is located on an edge side of the main frame; the second sub-frame is provided with a protrusion portion, the direction in which the protrusion portion protrudes is along the length direction of arrangement of the first sub-frame and the second sub-frame; the protrusion portion and the edge side of the main frame are in contact with the support surface to work as the second use support structure.

Alternatively, the first sub-frame is perpendicular to the main frame.

Optionally, the second sub-frame is perpendicular to the main frame.

Optionally, the main frame is a rectangular frame.

Optionally, a side of the first sub-frame that is away from the main frame is provided with a first bending portion; the first bending portion is recessed toward a side where the main frame is provided.

Optionally, each of the first sub-frame and the second sub-frame is provided with a first blocking rod for blocking the object from falling back and forth; the first blocking rod is fixed inside the first sub-frame or the second sub-frame; the first sub-frame is parallel to the second sub-frame, and each of a first straight rods is disposed in parallel.

Optionally, the first blocking rod are provided with a second bending portion; the second bending portion is recessed toward a side away from the main frame.

Optionally, the main frame is provided with a bottom blocking rod for supporting objects.

Optionally, the protrusion portion is provided with a mounting hole, and the mounting hole is able to cooperate with a screw to hang the protrusion portion on a wall.

Optionally, opposite sides of the main frame are respectively provided with a second blocking rod for blocking the object from falling in a direction perpendicular to the length direction of arrangement of the first sub-frame and the second sub-frame, and the second blocking rod is disposed at the length direction of arrangement of the first sub-frame and the second sub-frame.

Optionally, the first use support structure and the second use support structure are provided with rubber gaskets, respectively.

Optionally, the rubber gaskets are detachably installed on the main frame.

Optionally, the first sub-frame and the second sub-frame are detachably fixed to the main frame by an engaging structure, respectively.

Optionally, both of the first sub-frame and the second sub-frame comprise a pair of mounting support rods arranged opposite to each other, and a pair of the mounting support rods are respectively fixed on the main frame by an opening and closing structure;

the opening and closing structure comprises a U-shaped snapping member, the U-shaped snapping member is fixed on the mounting support rod, the edge of the main frame is able to be snapped into the U-shaped snapping member, and the two mounting support rods are able to elastically extruded two of the U-shaped snapping members.

As described above, the kitchen cabinet knock down style pan and pot lid organizer rack holder of the present disclosure has at least the following beneficial effects:

Through the arrangement of the first use support structure and the second use support structure, the kitchen cabinet knock down style pan and pot lid organizer rack holder can have two use states, one is that one side of the main frame is used as a support, and then the first sub-frame and the second sub-frame are in an upright state, so as to realize the support of the object. The other one is that one side of the second sub-frame and the main frame are used as a support, and then the first sub-frame and the second sub-frame are in a horizontal state to support the object. And the another one is that the protrusion portion is suspended in a vertical wall, at this time, the main frame is still in a horizontal state, and the first sub-frame and the second sub-frame can be placed in a horizontal state, which has a relatively flexible effect.

### BRIEF DESCRIPTION OF THE DRAWINGS

FIG. 1 is a schematic view showing a first use state of the kitchen cabinet knock down style pan and pot lid organizer rack holder according to the present disclosure.

FIG. 2 is a schematic view showing a second use state of the kitchen cabinet knock down style pan and pot lid organizer rack holder of the present disclosure.

FIG. 3 is a schematic view showing a first disassembly and assembly instruction of the second use state of the kitchen cabinet knock down style pan and pot lid organizer rack holder of the present disclosure.

FIG. 4 is a schematic view showing a second disassembly and assembly instruction of the second use state of the kitchen cabinet knock down style pan and pot lid organizer rack holder of the present disclosure.

FIG. 5 is a schematic view showing a first sub-frame of the present disclosure.

FIG. 6 is a schematic view showing a second sub-frame of the present disclosure.

FIG. 7 is a schematic view showing the main frame of the present disclosure.

FIG. 8 is a schematic view showing a gasket of the present disclosure.

Labeling instructions of the component are shown as below:
1 Main frame
2 First sub-frame
3 Second sub-frame
31 Protrusion portion
21 First bending portion
4 First blocking rods
11 Bottom blocking rod
12 Second blocking rods
41 Second bending portion
311 Mounting hole
312 Screw
13 Rubber gasket
131 C-shaped notch
5 Mounting support rod
6 U-shaped snapping member

### DETAILED DESCRIPTION OF THE EMBODIMENTS

The embodiments of the present disclosure are described below by way of specific embodiments, and those skilled in the art can easily understand other advantages and functions of the present disclosure from the disclosure.

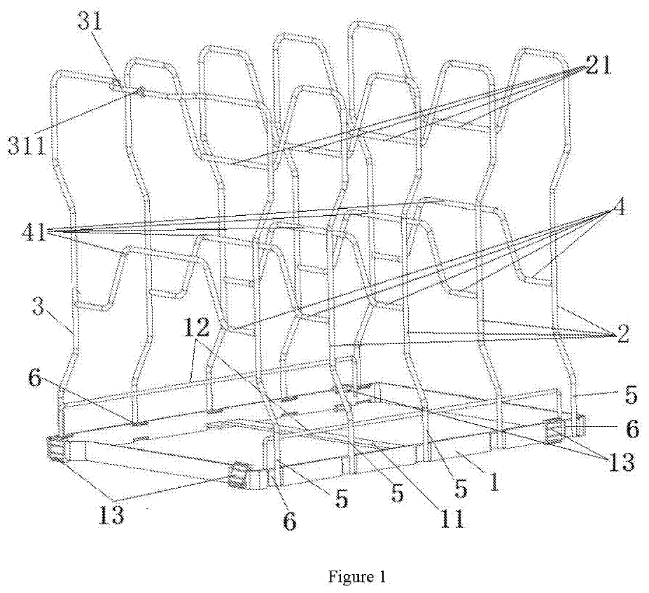

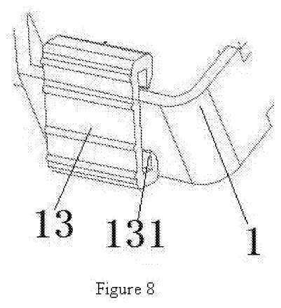

Please refer to FIGS. 1 to 8. It should be understood that the structures, the proportions, the sizes and the like, which are illustrated in the specification of the present specification, are only used to clarify the contents disclosed in the specification for understanding and reading by those skilled in the art, and are not intended to limit the implementation conditions of the present disclosure, so it is not substantial meaning to technology. Any modification of the structure, change of the proportional relationship or adjustment of the size should be within the scope of the disclosed technology of the present disclosure when it is without affecting the effects and the achievable purposes of the present disclosure. In the meantime, the terms “upper”, “lower”, “left”, “right”, “intermediate” and “one” as used in this specification are also for convenience of description, and are not intended to limit the scope of the present disclosure, and the change or adjustment of the relative relationship is considered to be within the scope of the disclosure when the content of the substantial technology is not changed.

The following various embodiments are merely illustrative. Combinations may be made between various embodiments, which are not limited to the contents presented by the single embodiment below.

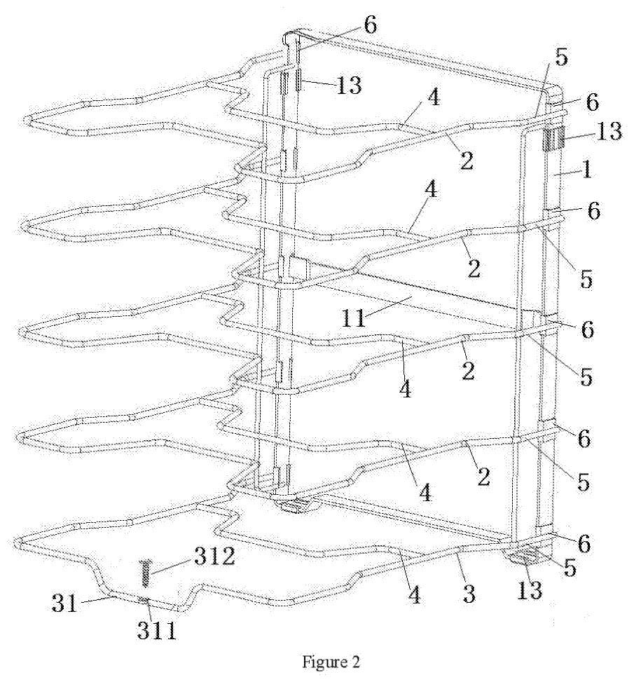

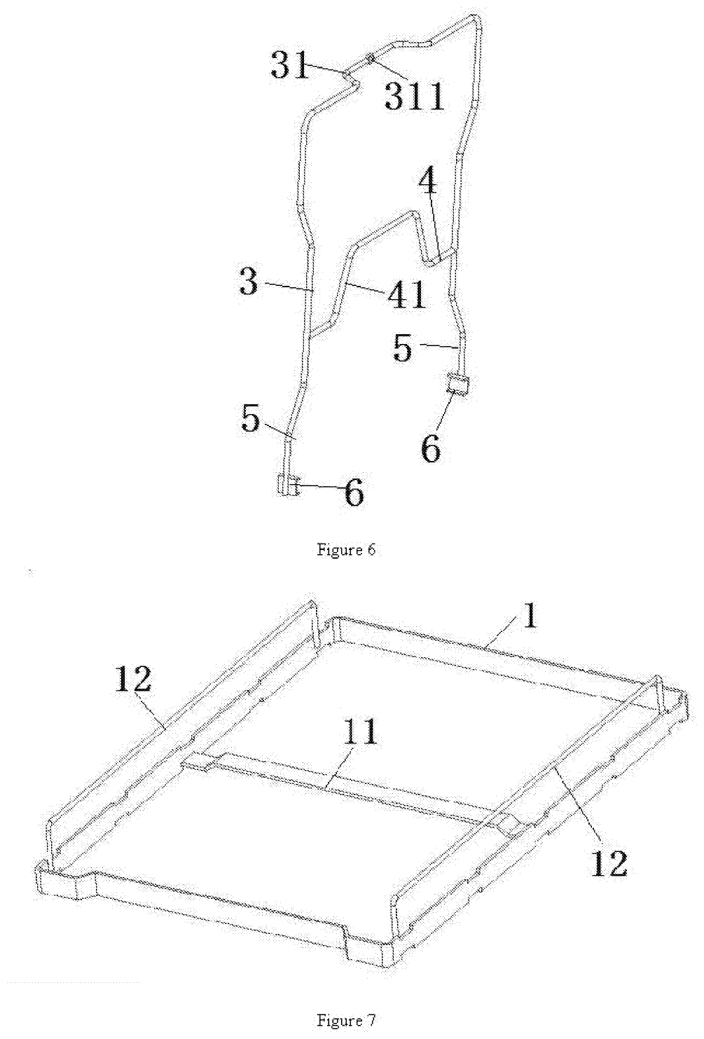

In the present embodiment, as shown in FIGS. 1 to 7, a kitchen cabinet knock down style pan and pot lid organizer rack holder includes a main frame 1, one or more first sub-frame 2 and one second sub-frame 3. Each of the at least one first sub-frame 2 is disposed at intervals, the first sub-frame 2 is mounted on one side of the main frame 1. The plane in which the main frame 1 is located is at an angle to the plane in which the first sub-frame 2 is located, and the other side of the main frame 1 can be in contact with the support surface to work as a first use support structure. The second sub-frame 3 and the first sub-frames 2 are arranged in parallel intervals or non-parallel intervals. the second sub-frame 3 is located on the edge side of the main frame 1. The second sub-frame 3 is provided with a protrusion portion 31, and please refer to FIG. 6, the second sub-frame 3 is bent to form the protrusion portion 31, and the direction in which the protrusion portion 31 protrudes is along the length direction of arrangement of the first sub-frame 2 and the second sub-frame 3. The protrusion portion 31 and the edge side of the main frame 1 are in contact with the support surface to work as the second use support structure. Through the arrangement of the first use support structure and the second use support structure, the kitchen cabinet knock down style pan and pot lid organizer rack holder can have two use states, one is that one side of the main frame 1 is used as a support, and then the first sub-frame 2 and the second sub-frame 3 are in an upright state, so as to realize the support of the object. The other one is that one side of the second sub-frame 3 and the main frame 1 are used as a support, and then the first sub-frame 2 and the second sub-frame 3 are in a horizontal state to support the object. And the another one is that the protrusion portion 31 is suspended in a vertical wall, at this time, the main frame 1 is still in a horizontal state, and the first sub-frame 2 and the second sub-frame 3 can be placed in a horizontal state, which has a relatively flexible effect. In the above use state, the object can be placed in the space between the first sub-frame 2 and the second sub-frame 3. When the first sub-frame 2 and the second sub-frame 3 are in the upright state, some of the objects that can be suspended is hung on the first sub-frame 2 or the second sub-frame 3. In the FIG. 1 and FIG. 2, the first sub-frame 2 and the second sub-frame 3 are both perpendicular to the main frame 1. In addition to the structure, the first sub-frame 2 and the second sub-frame 3 may be arranged in a non-orthogonal structure, such as the first sub-frame 2 is at an acute angle with the main frame 1, and the first sub-frames 2 is parallel to each other.

In this embodiment, referring to FIG. 1 to FIG. 2, the first sub-frame 2 is perpendicular to the main frame 1. The vertical structure enables the first sub-frame 2 to be in a vertical state when the main frame 1 is horizontal, and the space between the first sub-frames 2 is a storage space, which is easier for placing objects.

In this embodiment, referring to FIG. 1 to FIG. 2, the second sub-frame 3 is perpendicular to the main frame 1. On the one hand, its structure is more reliable, on the other hand, it is easier to place objects.

In this embodiment, referring to FIG. 1 to FIG. 6, one side of the first sub-frame 2 that is away from the main frame 1 is provided with a first bending portion 21. The first bending portion 21 is recessed toward one side where the main frame 1 is provided. By providing the first bending portion 21, when the object such as the lid and etc. is placed into the space between the first sub-frame 2 and the second sub-frame 3, a portion of the object can be exposed at the first bending portion 21. Thus, it more convenient to take out when needed, and the arm is prevented from being blocked by the first sub-frame 2. In order to achieve a better blocking effect, the first bending portion 21 can be provided as a horn-shaped concave structure.

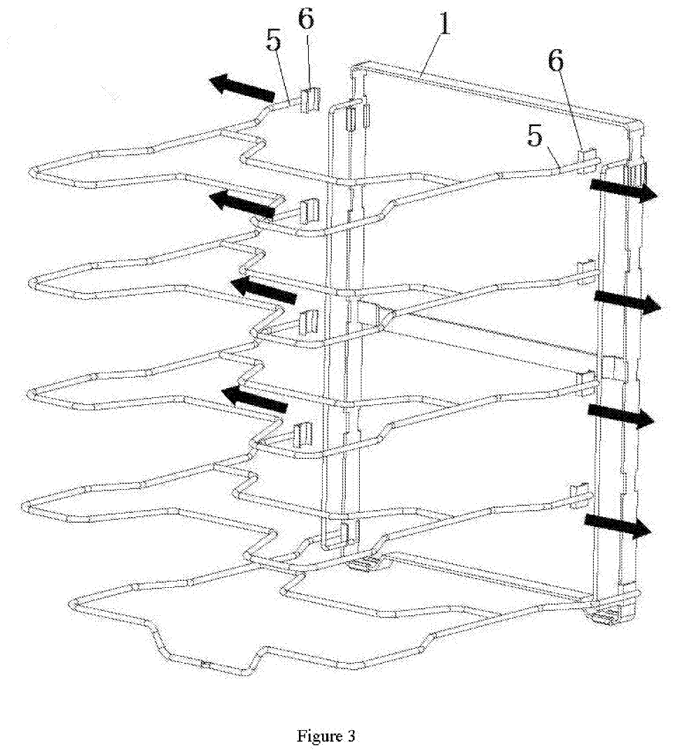

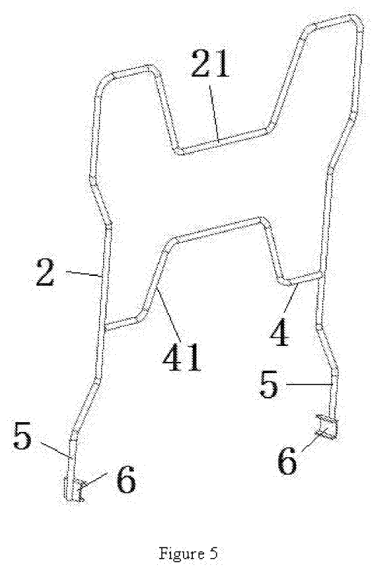

In this embodiment, referring to FIG. 1, FIG. 2, FIG. 3 and FIG. 5, the first sub-frame 2 and the second sub-frame 3 are respectively provided with first blocking rods 4 for blocking objects from falling back and forth. The first blocking rods 4 are fixed inside the first sub-frame 2 or the second sub-frame 3, and the first sub-frame 2 is parallel to the second sub-frame 3. Each of the first straight rods is disposed in parallel. The first blocking rod 4 can block the loaded objects in the front-rear direction to prevent them from falling down. The first blocking rod 4 is provided with a second bending portion 41, and the second bending portion 41 is recessed toward the side away from the main frame 1, which can block the object at a higher height, and can better avoid object from tilting.

In this embodiment, referring to FIG. 1, FIG. 2, FIG. 3 and FIG. 6, the main frame 1 is provided with a bottom blocking rod 11 for supporting objects. The function here is the same as that of the first blocking rod 4, and it will not be described here for brevity.

In this embodiment, referring to FIG. 2 and FIG. 3, the protrusion portion 31 is provided with a mounting hole 311, and the mounting hole 311 can cooperate with the screw 312 to hang the protrusion portion 31 on the wall.

In the present embodiment, referring to FIG. 1 to FIG. 4, opposite sides of the main frame 1 are respectively provided with a second blocking rod 12 for blocking the objects from falling in a direction perpendicular to the length direction of arrangement of the first sub-frame and the second sub-frame, and the second blocking rods 12 are arranged at the length direction of arrangement of the first sub-frames 2 and the second sub-frame 3. The arrangement of the second blocking rods 12 can effectively prevent the objects from falling from the left-right direction.

In this embodiment, referring to FIG. 1 to FIG. 4 and FIG. 8, the first use support structure and the second use support structure are respectively provided with rubber gasket 13. The rubber gasket 13 can provide an anti-slip effect while protecting the table or the wall surface. In order to achieve replaceability of the rubber gasket, the rubber gasket 13 is detachably installed on the main frame 1. The specific detachable structure may be provided with a C-shaped notch 131 on the rubber gasket 13, and the C-shaped notch 131 and the frame of the main frame 1 are interference fit.

In this embodiment, referring to FIG. 1 to FIG. 6, the first sub-frame 2 and the second sub-frame 3 are detachably fixed to the main frame 1 by an engaging structure. Optionally, both of the first sub-frame 2 and the second sub-frame 3 include a pair of mounting support rods 5 disposed opposite to each other, and a pair of the mounting support rods 5 are respectively fixed on the main frame 1 by the opening and closing structure. The opening and closing structure includes a U-shaped snapping member 6 and the U-shaped snapping member 6 is fixed on the mounting support rod 5. The edge of the main frame 1 can be inserted into the U-shaped snapping member 6 and the two mounting support rods are capable of elastically pressing the two U-shaped snapping members 6. That is, the first mounting support rod 5 and the second mounting support rod 5 can be elastically deformed by the first sub-frame 2 or the second sub-frame 3. Because the first sub-frame 2 and the second sub-frame 3 are framed structures, the material can be specifically steel structure or plastic structure, which can meet the requirements of elastic deformation. It can seen from FIGS. 5 and 6, the first sub-frame 2 and the second sub-frame 3 are bent from a steel bar, respectively.

In FIG. 3, when the first sub-frame 2 is disassembled, the mounting support rod 5 is opened to the left and right sides. In FIG. 3, the direction indicated by the arrow is the direction in which the force is applied, the U-shaped snapping member 6 is aligned to the main frame 1 and then is released from the external force to realize the installation and disassembly. In order to avoid the sliding of the U-shaped snapping member 6 on the main frame 1, a stop structure can be correspondingly arranged on the main frame 1.

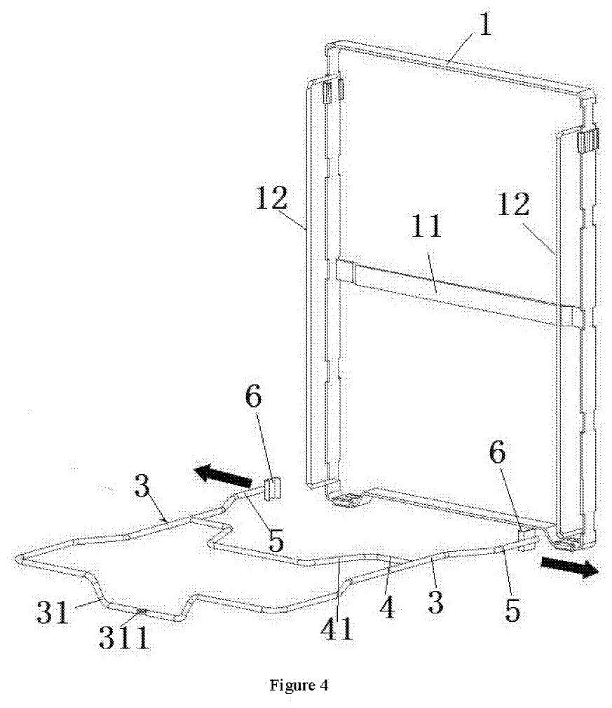

In FIG. 4, when the second sub-frame 3 is disassembled, the mounting support rod 5 is opened to the left and right sides. In FIG. 4, the direction indicated by the arrow is the direction in which the force is applied, the U-shaped snapping member 6 is aligned to the main frame 1 and then is released from the external force to realize the installation and disassembly. In order to avoid the sliding of the U-shaped snapping member 6 on the main frame 1, a stop structure can be correspondingly arranged on the main frame 1.

In summary, the present disclosure is to use the arrangement of the first use support structure and the second use support structure, the kitchen cabinet knock down style pan and pot lid organizer rack holder can have two use states, one is that one side of the main frame 1 is used as a support, and then the first sub-frame 2 and the second sub-frame 3 are in an upright state, so as to realize the support of the object. The other one is that one side of the second sub-frame 3 and the main frame 1 are used as a support, and then the first sub-frame 2 and the second sub-frame 3 are in a horizontal state to support the object. And the another one is that the protrusion portion 31 is suspended in a vertical wall, at this time, the main frame 1 is still in a horizontal state, and the first sub-frame 2 and the second sub-frame 3 can be placed in a horizontal state, which has a relatively flexible effect and a low cost. Therefore, the present disclosure effectively overcomes various shortcomings in the prior art and has high industrial utilization value.

The above-described embodiments are merely illustrative of the principles and effects of the present disclosure, and are not intended to limit the present disclosure. Modifications or variations of the above-described embodiments may be made by those skilled in the art without departing from the spirit and scope of the present disclosure. Therefore, all equivalent modifications or changes made by those skilled in the art without departing from the spirit and scope of the present disclosure will be included by the appended claims.

What is claimed is:

1. A kitchen cabinet knock down style pan and pot lid organizer rack holder, comprising:
a main frame;
at least one first sub-frame, wherein each of the at least one first sub-frame is disposed at intervals, the first sub-frame is mounted on one side of the main frame; a plane in which the main frame is located is at an angle to a plane in which the first sub-frame is located, and the other side of the main frame is in contact with a support surface to work as a first use support structure;
the second sub-frame, wherein the second sub-frame and the first sub-frames are arranged in parallel intervals or non-parallel intervals, the second sub-frame is located on an edge side of the main frame; the second sub-frame is provided with a protrusion portion, a direction in which the protrusion portion protrudes is along a length direction of arrangement of the first sub-frame and the second sub-frame; the protrusion portion and the edge side of the main frame are in contact with the support surface to work as the second use support structure.

2. The kitchen cabinet knock down style pan and pot lid organizer rack holder according to claim 1, wherein the first sub-frame is perpendicular to the main frame.

3. The kitchen cabinet knock down style pan and pot lid organizer rack holder according to claim 1, wherein the second sub-frame is perpendicular to the main frame.

4. The kitchen cabinet knock down style pan and pot lid organizer rack holder according to claim 1, wherein the main frame is a rectangular frame.

5. The kitchen cabinet knock down style pan and pot lid organizer rack holder according to claim 1, wherein a side of the first sub-frame that is away from the main frame is provided with a first bending portion; the first bending portion is recessed toward a side where the main frame is provided.

6. The kitchen cabinet knock down style pan and pot lid organizer rack holder according to claim 1, wherein the first sub-frame and the second sub-frame are provided with a first blocking rod for blocking objects from falling back and forth, respectively; the first blocking rod is fixed inside the first sub-frame or the second sub-frame; the first sub-frame is parallel to the second sub-frame, and each of a first straight rods is disposed in parallel.

7. The kitchen cabinet knock down style pan and pot lid organizer rack holder according to claim 6, wherein the first blocking rod is provided with a second bending portion; the second bending portion is recessed toward a side away from the main frame.

8. The kitchen cabinet knock down style pan and pot lid organizer rack holder according to claim 1, wherein the main frame is provided with a bottom blocking rod for supporting the objects.

9. The kitchen cabinet knock down style pan and pot lid organizer rack holder according to claim 1, wherein the protrusion portion is provided with a mounting hole, and the mounting hole is matched with a screw to fix the protrusion portion on a wall.

10. The kitchen cabinet knock down style pan and pot lid organizer rack holder according to claim 1, wherein opposite sides of the main frame are respectively provided with a second blocking rod for blocking the objects from falling in a direction perpendicular to the length direction of arrangement of the first sub-frame and the second sub-frame, and the second blocking rod is arranged along the length direction of arrangement of the first sub-frame and the second sub-frame.

11. The kitchen cabinet knock down style pan and pot lid organizer rack holder according to claim 1, wherein the first use support structure and the second use support structure are provided with rubber gaskets, respectively.

12. The kitchen cabinet knock down style pan and pot lid organizer rack holder according to claim 11, wherein the rubber gaskets are detachably installed on the main frame.

13. The kitchen cabinet knock down style pan and pot lid organizer rack holder according to claim 1, wherein the first sub-frame and the second sub-frame are detachably fixed to the main frame by an engaging structure, respectively.

14. The kitchen cabinet knock down style pan and pot lid organizer rack holder according to claim 13, wherein both of the first sub-frame and the second sub-frame comprise a pair of mounting support rods arranged opposite to each other, and a pair of the mounting support rods are respectively fixed on the main frame by an opening and closing structure;
the opening and closing structure comprises a U-shaped snapping member, the U-shaped snapping member is fixed on the mounting support rod, an edge of the main frame is able to be snapped into the U-shaped snapping member, and each of the two mounting support rods is able to elastically squeeze the U-shaped snapping member.
